(19) United States
(12) Patent Application Publication
(10) Pub. No.: US 2003/0221086 A1
(43) Pub. Date: Nov. 27, 2003

(54) Configurable stream processor apparatus and methods

(76) Inventors: Slobodan A. Simovich, Sunnyvale, CA (US); Ivan P. Radivojevic, San Francisco, CA (US); Erik Ramberg, Seattle, WA (US)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/367,512

(22) Filed: Feb. 13, 2003

Related U.S. Application Data
(60) Provisional application No. 60/356,691, filed on Feb. 13, 2002.

(51) Int. Cl. G06F 15/76

(52) U.S. Cl. 712/4

(57) ABSTRACT

Data processing apparatus and methods capable of executing vector instructions. Such apparatus preferably include a number of data buffers whose sizes are configurable in hardware and/or in software; a number of buffer control units adapted to control access to the data buffers, at lease one buffer control unit including at least one programmable write pointer register, read pointer register, read stride register and vector length register; a number of execution units for executing vector instructions using input operands stored in data buffers and storing produced results to data buffers; and at least one Direct Memory Access channel transferring data to and from said buffers. Preferably, at least some of the data buffers are implemented in dual-ported fashion in order to allow at least two simultaneous accesses per buffer, including at least one read access and one write access. Such apparatus and methods are advantageous, among other reasons, because they allow: (a) flexibility and simplicity of low-cost general-purpose RISC processors, (b) vector instructions to achieve high throughput on scientific real-time applications, and (c) configurable hardware buffers coupled with programmable Direct Memory Access (DMA) channels to enable the overlapping of data I/O and internal computations.

### FIELD

This invention relates to general digital data processing and vector instruction execution.

### STATE OF THE ART

Over the past four decades, numerous computer architectures have been proposed to achieve a goal of high computational performance on numerically intensive (“scientific”) applications. One of the earliest approaches is vector processing. A single vector instruction specifies operation to be repeatedly performed on the corresponding elements of input data vectors. For example, a single Vector Add instruction can be used to add the corresponding elements of two 100-element input arrays and store the results in a 100-element output array. Vector instructions eliminate the need for branch instruction and explicit operand pointer updates, thus resulting in a compact code and fast execution of operations on large data sets. Input and output arrays are typically stored in vector registers. For example, Cray research Inc. Cray-1 supercomputer, described in the magazine “Communications of the ACM”, January 1978, pp. 63-72, which is incorporated herein by this reference, has eight 64-element vector registers. In Cray-1, access to individual operand arrays is straightforward, always starting from the first element in a vector register. A more flexible scheme was implemented in Fujitsu VP-200 supercomputer described in the textbook published by McGraw-Hill in 1984, “Computer Architecture and Parallel Processing”, pp. 293-301 which is incorporated herein by this reference. There, a total storage for vector operands can accommodate 8192 elements dynamically configurable as, for example, 256 32-element vector registers or 8 1024-element vector registers. Vector supercomputers typically incorporate multiple functional units (e.g. adders, multipliers, shifters). To achieve higher throughput by overlapping execution of multiple time-consuming vector instructions, operation chaining between a vector computer's functional units is sometimes implemented, as disclosed in U.S. Pat. No. 4,128,880 issued Dec. 5, 1978 to S. R. Cray Jr. which is incorporated herein by this reference. Due to their complexities and associated high costs, however, vector supercomputers' installed base has been limited to relatively few high-end users such as, for example, government agencies and top research institutes.

Over the last two decades, there have been a number of single-chip implementations optimized for a class of digital signal processing (DSP) calculations such as FIR/IIR filters or Fast Fourier Transform. A DSP processor family designed by Texas Instruments Corporation is a typical example of such special-purpose designs. It provides dedicated “repeat” instructions (RPT, RPTK) to implement zero-overhead loops and simulate vector processing of the instruction immediately following a “repeat” instruction. It does not implement vector registers, but incorporates on-chip RAM/ROM memories that serve as data/coefficient buffers. The memories are accessed via address pointers updated under program control (i.e. pointer manipulations are encoded in instructions). Explicit input/output (I/O) instructions are used to transfer data to/from on-chip memories, thus favoring internal processing over I/O transactions. More information on the mentioned features is disclosed in U.S. Pat. No. 4,713,749 issued Dec. 15, 1987 to Magar et al., which is incorporated herein by this reference.

In practice, to meet ever-increasing performance targets, complex real-time systems frequently employ multiple processing nodes. In such systems, in addition to signal processing calculations, however, a number of crucial tasks may involve various bookkeeping activities and data manipulations requiring flexibility and programmability of general-purpose RISC (Reduced Instruction Set Computer) processors. Moreover, an additional premium is put to using low-cost building blocks that have interfaces capable of transferring large sets of data.

Accordingly, it is an object of certain embodiments of the present invention to provide computer architecture and a microcomputer device based on the said architecture which features: (a) flexibility and simplicity of low-cost general-purpose RISC processors, (b) vector instructions to achieve high throughput on scientific real-time applications, and (c) configurable hardware buffers coupled with programmable Direct Memory Access (DMA) channels to enable the overlapping of data 1/0 and internal computations. Other such objects include to be able to efficiently exploit such devices in multiprocessor systems and processes.

### SUMMARY

Configurable Stream Processors (CSP) according to certain aspects and embodiments of the present invention include a fully-programmable Reduced Instruction Set Computer (RISC) implementing vector instructions to achieve high throughput and compact code. They extend the concept of vector registers by implementing them as configurable hardware buffers supporting more advanced access patterns, including, for example, First-In-First-Out (FIFO) queues, directly in hardware. Additionally, the CSP buffers are preferably dual-ported and coupled with multiple programmable DMA channels allowing the overlapping of data I/O and internal computations, as well as glueless connectivity and operation chaining in multi-CSP systems.

### BRIEF DESCRIPTION

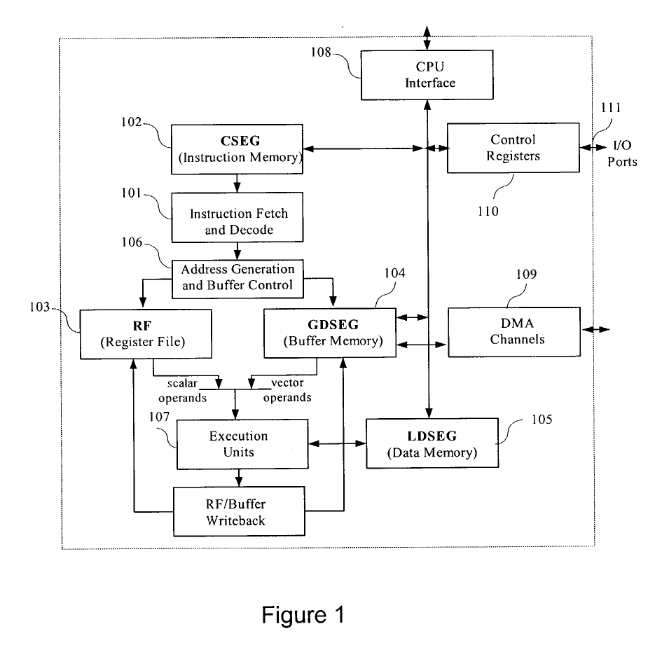

FIG. 1 is a schematic diagram that introduces certain Configurable Stream Processor (CSP) Architecture according to one embodiment of the present invention, including memory segments, I/O interfaces and execution and control units.

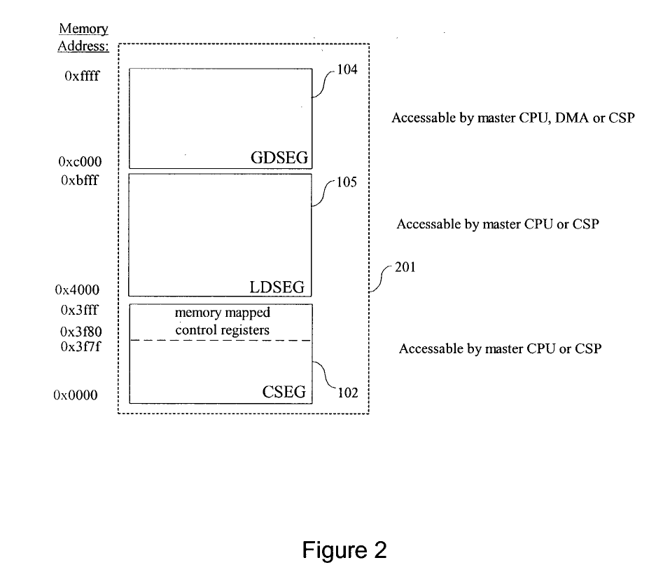

FIG. 2 depicts CSP memory subsystem organization of the embodiment shown in FIG. 1.

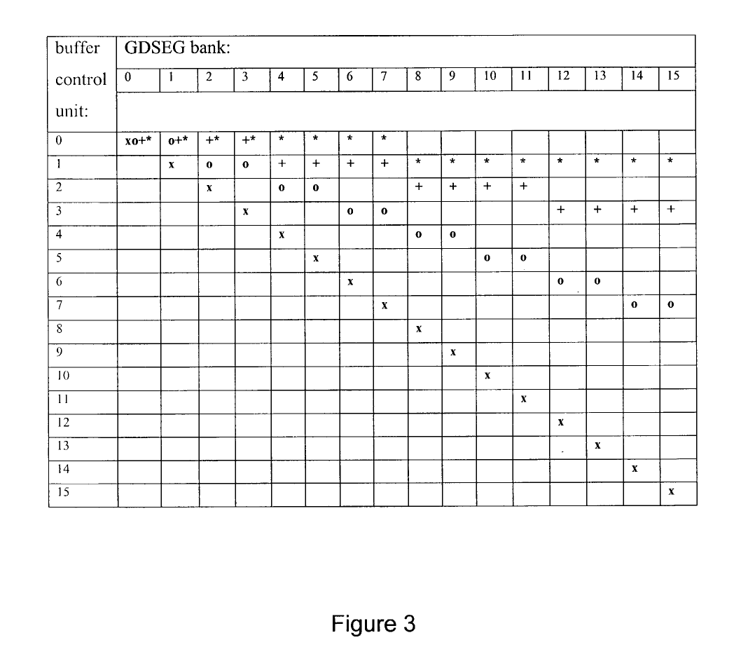

FIG. 3 presents logical (architectural) mapping between buffer control units and memory banks implementing CSP buffers of the embodiment shown in FIG. 1.

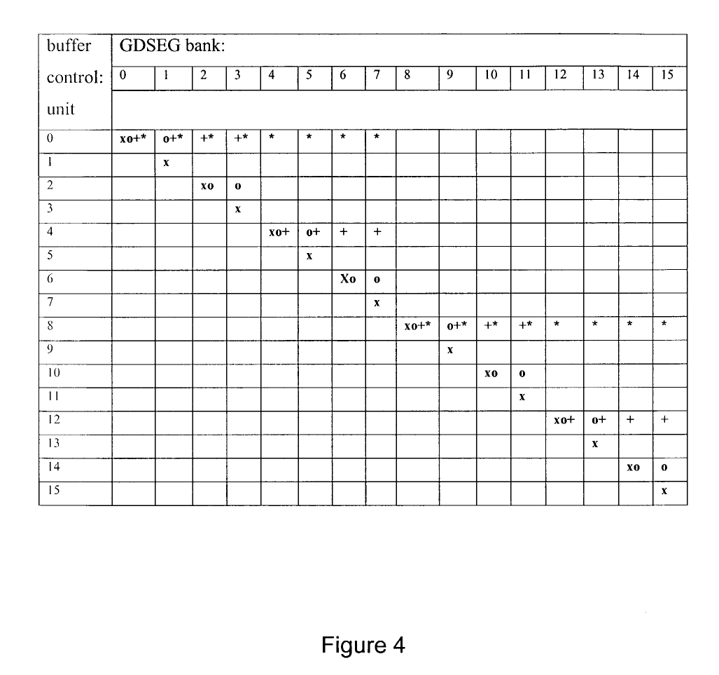

FIG. 4 presents physical (implementation) mapping between buffer control units and memory banks implementing CSP buffers of the embodiment shown in FIG. 1.

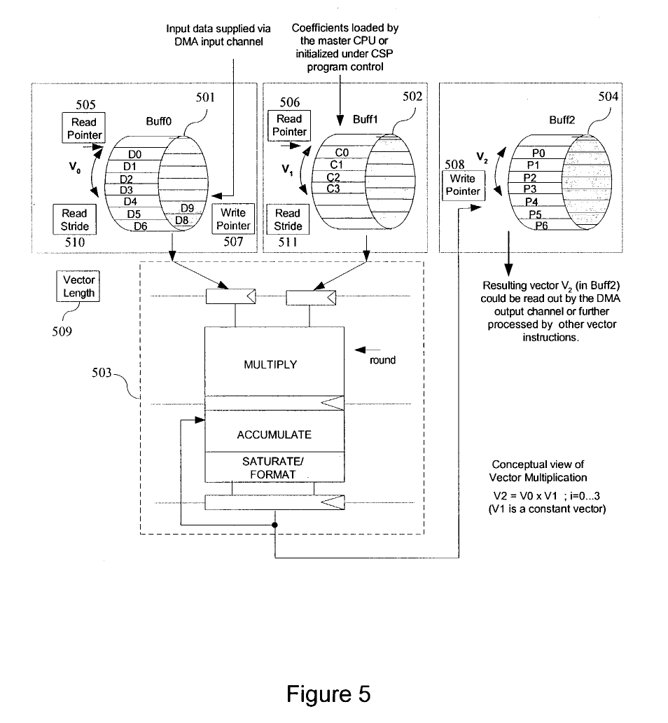

FIG. 5 illustrates use of CSP buffers such as in FIG. 1 in a typical signal processing application.

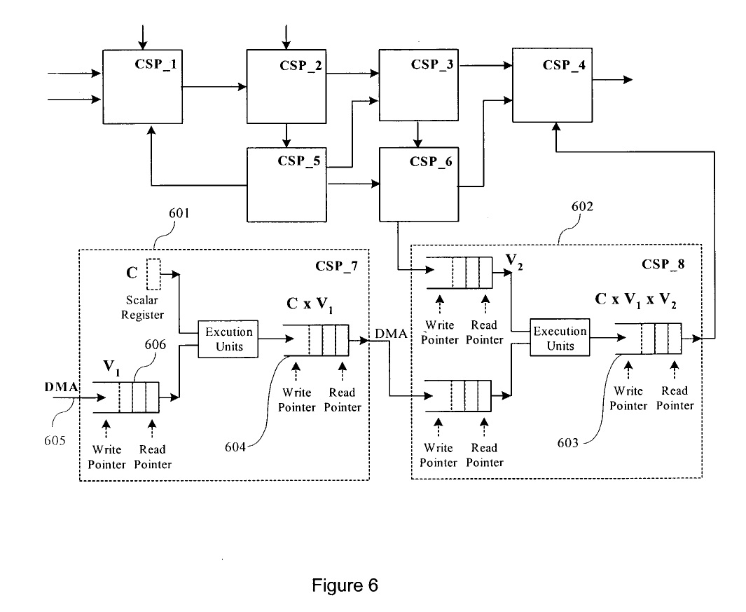

FIG. 6 illustrates how a CSP such as in FIG. 1 can be used in a multiprocessing system and indicates how a particular algorithm can be mapped to a portion of the system.

### DETAILED DESCRIPTION

CSP's according to various aspects and embodiments of the invention use programmable, hardware-configurable architectures optimized for processing streams of data. To this end, such CSP's can provides or enable, among other things:

data input/output (I/O) operations overlapped with calculations;

vector instructions;

architectural and hardware support for buffers; and

hardware/software harness for supporting intra-CSP connectivity in multi-CSP systems.

This section is organized as follows. First is presented an overview of CSP architecture. Second is discussed CSP memory subsystem, architectural registers and instruction set. Third is discussed CSP buffer management as well as an illustration of CSP multiprocessing features. One focus there is on a role that buffers play as interface between fast Direct Memory Access (DMA) based I/O and vector computations that use buffers as vector register banks.

Overview of CSP Architecture and Implementation

FIG. 1 shows one embodiment of a Configurable Stream Processor (CSP) according to the present invention. Instruction Fetch and Decode Unit 101 fetches CSP instructions from CSEG Instruction Memory 102 [code segment (memory area where the program resides)]. Once instructions are decoded and dispatched for execution, instruction operands come from either a scalar Register File 103, GDSEG Buffer Memory 104 [global data segment (memory area where CSP buffers reside)] or LDSEG Data Memory 105 [local data segment (general-purpose load/store area]. Buffer Control Units 106 generate GDSEG addresses and control signals. Instruction execution is performed in Execution Units 107 and the results are stored to Register File 103, Buffer Memory 104 or Data Memory 105. Additionally, shown in FIG. 1 are: the master CPU interface 108, Direct Memory Access (DMA) Channels 109 and a set of Control Registers 110 that include CSP I/O ports 111.

Memory Subsystem

FIG. 2 depicts one form of CSP memory subsystem organization according to various aspects and embodiments of the invention. In the presented memory map 201, boundary addresses are indicated in a hexadecimal format. The architecture supports physically addressed memory space of 64K 16-bit locations. Three non-overlapping memory segments are defined: CSEG 102, LDSEG 105, and GDSEG 104.

The particular architecture of FIG. 1 defines the maximum sizes of CSEG 102, LDSEG 105 and GDSEG 104 to be 16K, 32K, and 16K 16-bit locations, respectively, although these may be any desired size.

As shown in FIG. 1, CSP memory space can be accessed by the three independent sources: the master CPU (via CPU interface 108), the DMA 109 and the CSP itself. GDSEG 104 is accessible by the master CPU, DMA channels and the CSP. LDSEG 105 and CSEG 102 are accessible by the master CPU and CSP, only. GDSEG 104 is partitioned in up to 16 memory regions and architectural buffers (vector register banks) are mapped to these regions. As shown in FIG. 2, CSP Control Registers are preferably memory-mapped to the upper portion of CSEG 102.

In a typical application, the master CPU does CSP initialization (i.e. downloading of CSP application code into CSEG 102 and initialization of CSP control registers 110). CSP reset vector (memory address of the first instruction to be executed) is 0x0000.

Architectural Registers

Scalar Registers

The architecture can define a Register File 103 containing 16 general-purpose scalar registers. All scalar registers in this embodiment are 16-bit wide. Register So is a constant “0” register. Registers S₈ (MLO) and S₉ (MHI) are implicitly used as a 32-bit destination for multiply and multiply-and-add instructions. For extended-precision (40-bit) results, 8 special-purpose bits are reserved within Control Register space.

Control Registers

CSP Control Registers according to the embodiment shown in FIG. 1 are memory-mapped (in CSEG 102) and are accessible by both CSP and the external CPU. Data is moved between control and scalar registers using Load/Store instructions. There are 8 Master Control Registers: 2 status registers, 5 master configuration registers and a vector instruction length register. Additionally, 85 Special Control Registers are provided to enable control of a timer and individual DMA channels 109, buffers 104, interrupt sources and general-purpose I/O pins 111. Most of the control registers are centralized in 110. Buffer address generation is preformed using control registers in Buffer Control Units 106. The first CSP implementation has 4 input DMA channels and 4 output DMA channels. All DMA channels are 16-bit wide. Additionally, 8 16-bit I/O ports (4 in and 4 out) are implemented.

Buffers (Vector Registers)

CSP architecture according to the embodiment of FIG. 1 defines up to 16 buffers acting as vector registers. The buffers are located in GDSEG Buffer Memory 104. The number of buffers and their size for a particular application is configurable. A modest, initial example CSP implementation supports 16 128 entry buffers, 8 256-entry buffers, 4 512-entry buffers, or 2 1024-entry buffers.

GDSEG memory space 104 in the embodiment of FIG. 1 is implemented as 16 128-entry dual-ported SRAM memories (GDSEG banks) with non-overlapping memory addresses. Additionally, there are 16 Buffer Control Units 106. Each buffer control unit has dedicated Read and Write pointers and could be configured to implement circular buffers with Read/Write pointers being automatically updated on each buffer access and upon vector instruction completion.

The following is a summary of operation of the control registers involved in buffer address generation in the embodiment shown in FIG. 1:

The Write Pointer register is automatically incremented on each buffer write access (via DMA or vector instruction).

The Read Pointer register is automatically either incremented or decremented on each data buffer read access via a vector instruction.

The Read Pointer register is automatically incremented on each data buffer read access via DMA transfer.

One additional “Read Stride” register is assigned per buffer control unit. At the end of a vector instruction, the Read Pointer(s) corresponding to vector instruction's input operand(s) is automatically updated by assigning to it a new value equal to a value of the Read pointer before the vector instruction execution incremented by a value contained in the Read Stride register.

These three registers (i.e., Read Pointer, Write Pointer and Read Stride) are implemented in each buffer control unit and allow independent control of individual buffers (vector registers). Additionally, they enable very efficient execution of common signal processing algorithms (e.g. decimating FIR filters).

Effective range (bit-width) of Read/Write Pointer registers used in buffer addressing is equal to the active buffer size and address generation arithmetic on contents of these registers is preferably performed modulo buffer size. Thus, for example, in a 16-buffer configuration, buffer address generation uses modulo-128 arithmetic (i.e. register width is 7 bits). To illustrate this, assume that the content of Write Pointer register is 127. If the register's content is incremented by 1, the new value stored in Write Pointer will be 0 (i.e. not 128, as in ordinary arithmetic). Similarly, in a 2-buffer configuration, modulo-1024 arithmetic is used to update Read/Write Pointer registers (i.e. register width is 10 bits).

In a 16-buffer configuration, each buffer control unit controls access to individual GDSEG banks. In an 8-buffer configuration, pairs of GDSEG banks act as 256-entry buffers. For example, banks 0 and 1 correspond to architectural buffer 0, banks 2 and 3 correspond architectural buffer 1 and so on. Similarly, groups of 4 or 8 consecutive GDSEG banks act as enlarged buffers for 4-buffer and 2-buffer configurations, respectively. An example logical (architectural) mapping between buffer control units and GDSEG banks is shown in FIG. 3. In FIGS. 3 and 4, “x” indicates that a GDSEG bank belongs to a 128-entry buffer. Similarly, “o”, “+” and “*” indicate a GDSEG bank being a part of a larger 256-entry, 512-entry or 1024-entry buffer, respectively.

Notice that in FIG. 3, buffer control unit 1 (and its corresponding Read/Write pointer registers) would have to access 15 GDSEG memory banks. To make connectivity between buffer control units and GDSEG banks more regular, actual (physical) mapping can be implemented as shown in FIG. 4. In a 16-buffer configuration, there are no differences between FIGS. 3 and 4 (i.e. logical and physical mappings are identical). In an 8-buffer configuration, however, buffer 1 (comprising of GDSEG banks 2 and 3) is controlled by the physical buffer control unit 2. Similarly, in a 4-buffer configuration, buffer 1 (comprising of GDSEG banks 4, 5, 6, and 7) is controlled by the physical buffer control unit 4. Finally, in a 2-buffer configuration, buffer 1 (comprising of GDSEG banks 8, 9, 10, 11, 12, 13, 14 and 15) is controlled by the physical buffer control unit 8. The re-mapping of buffer control units is hidden from a software programmer. For example, in an 8-buffer configuration, buffer 1 appears to be is controlled by the architectural buffer control unit 1, as defined by the CSP Instruction Set Architecture.

CSP buffer configuration programmability can be implemented via hardware (including using CSP external pins) and/or software (including using CSP control registers).

Instruction Set

A preferred form of CSP instruction set according to certain aspects and embodiments of the invention defines 52 instructions. All such instructions are preferably 16 bits wide, four instruction formats are preferably defined, and these may be conventional and are in any event within the ambit of persons of ordinary skill in this art. There are five major instruction groups:

Arithmetic instructions (scalar and vector add, subtract, multiply and multiply-accumulate),

Scalar and vector load/store instructions and buffer push/pop instructions,

Scalar and vector shift instructions,

Logic and bit manipulation instructions (scalar only), and

Control flow instructions (jump, branch, trap, sync, interrupt return)

Arithmetic vector instruction input operands can be either both of a vector type (e.g. add two vectors) or can be of a mixed vector-scalar type (e.g. add a scalar constant to each element of a vector). Transfer of vector operands between LDSEG 105 and GDSEG 104 is preferably performed using vector load/store instructions. Transfer of scalar operands between scalar Register File 103 and GDSEG Buffer Memory 104 is performed using push/pop instructions.

All CSP operands according to the embodiment shown in FIG. 1 are 16 bits wide. The only exceptions are multiply-and-accumulate instructions that have 32-bit or 40-bit (extended precision) results. This CSP embodiment supports both 2's complement and Q15 (i.e., 16-bit fractional integer format normalized between [−1,+1)) operand formats and arithmetic. Additionally, rounding and saturation-on-overflow modes are supported for arithmetic operations. Synchronization with external events is done via interrupts, SYNC instruction and general-purpose I/O registers. Finally, debug support can be provided by means of single-stepping and TRAP (software interrupt) instruction.

Buffer Management and CSP Multiprocessing

Multiple DMA (Direct Memory Access) channels according to the embodiment shown in FIG. 1 enable burst transfer of sets of I/O data. Moreover, such transfers can take place in parallel to internal arithmetic calculations that take advantage of the CSP's vector instructions. A single vector instruction specifies operation to be performed on the corresponding elements of input data vectors. For example, a single Vector Add (VADD) instruction can be used to add the corresponding elements of two 100-element input arrays and store the results in a 100-element output array. Similarly, a vector multiply-and-accumulate (VMAC) instruction multiplies the corresponding elements of two input arrays while simultaneously accumulating individual products. Vector instructions eliminate the need for branch instruction and explicit operand pointer updates, thus resulting in a compact code and fast execution of operations on long input data sets. Such operations are required by many DSP applications. In the CSP architecture, shown in FIG. 1, there is a central Vector Length register defining a number of elements (array length) on which vector instructions operate. This register is under explicit software control.

As an interface between I/O and internal processing, the CSP architecture of FIG. 1 defines a set of hardware buffers and provides both software and hardware support for buffer management. Each buffer has one read port and one write port. Consequently, a simultaneous access is possible by one producer and one consumer of data (e.g. “DMA write, vector instruction read” or “Vector instruction write, DMA read”). Hardware buffers have their dedicated Read and Write pointers and could be configured to implement circular buffers with Read/Write pointers being automatically updated on each buffer access and upon vector instruction completion.

FIG. 5 illustrates use of CSP buffers in a typical signal processing application. There, a data vector V₀ residing in Buff0 buffer 501 is multiplied by a constant vector V₁ residing in Buff1 buffer 502. Multiplication of the corresponding input vector elements is done using Multiply and Accumulate Unit 503 and the produced output vector V₂ elements are stored in Buff2 buffer 504. Reading of individual input operands is performed using the corresponding buffer Read Pointer registers 505 and 506. New data elements are stored in Buff0 buffer 501 using its Write Pointer register 507. Similarly, vector multiplication outputs are stored in Buff2 buffer 504 using its Write Pointer register 508. In a typical CSP on-line processing application, a programmable DMA channel could provide new data elements for buffer 501. Coefficients stored in buffer 502 could be loaded by the master CPU or initialized under CSP program control prior to the vector instruction execution. Finally, outputs stored in Buff2 buffer 504, could be used by some other CSP instruction or could be read out via programmable DMA channel and sent to some other CSP.

As an example, assume the following:

Vector Length register 509 is set to 4;

Read Pointer 505 initially points to data element D0 in Buff0 501;

Read Pointer 506 initially points to coefficient C0 in Buff1 502;

Write Pointer 508 initially points to location P0 in Buff2 504;

Read Stride register 510 corresponding to Buff0 501 is set to 4; and

Read Stride register 511 corresponding to Buff1 502 is set to 0.

The following results are produced on the first execution of the vector multiply instruction:

{P0, P1, P2, P3}={(D0×C0), (D1×C1), (D2×C2), (D3×C3)}

Similarly, the following results are produced on the second execution of the vector multiply instruction:

{P4, P5, P6, P7}={(D4×C0), (D5×C1), (D6×C2), (D7×C3)}

The software programmer has access to individual buffer control and status information (Read Pointer, Write Pointer, Full/Empty and Overflow/Underflow status). Additionally, interrupts can be generated as a result of a buffer overflow/underflow condition. Similarly, a termination of a DMA transfer can trigger an interrupt or activate SYNC instruction that stalls the CSP until a particular condition is met.

Support for Operation Chaining in Systems Consisting of Multiple CSPs

In addition to explicit synchronization via the SYNC instruction or interrupt, implicit process synchronization can be provided as well.

Buffer hardware support is implemented in such a fashion that it prohibits starting a vector instruction if any of its source buffers are empty.

Similarly, no DMA transfer (including a burst transfer of multiple data items on consecutive clock cycles) can start out of an empty buffer.

As apparent to those skilled in the art, since in the CSP architecture shown in FIG. 1 each buffer has its corresponding Read and Write Pointer registers, a buffer empty condition is easily detected on per buffer basis.

It is important to note that both DMA transfers and vector instructions can operate at full-speed: a new data item can be delivered by a DMA channel at every clock cycle and a vector instruction can accept new input operands every clock cycle as well. Additionally, DMA channels can be pre-programmed to continuously transfer bursts of data of the specified length. Thus, the following execution scenario is possible: The arrival of the first element of input data set (via DMA) can trigger execution of a CSP vector instruction. Thus, vector operation can start execution before a whole set of its input data is available. Similarly, the first element of the result vector can trigger DMA output operation. This, in turn, can trigger execution of another vector instruction on some other CSP programmed to receive output from the first vector instruction.

Such execution semantics are advantageous in several ways:

Code can be compact since no explicit instructions are needed to achieve synchronization on buffer data availability.

Additionally, since no explicit synchronization code execution is needed, synchronization overhead is eliminated and time available for actual data processing (computation) is correspondingly increased.

Finally, since synchronization is achieved on the arrival of the first data element (i.e. without waiting for the whole array to be transferred), overlap between I/O and computation is maximized as well.

Using DMA channels and general-purpose I/O ports, multiple CSPs can be interconnected to perform a variety of intensive signal processing tasks without additional hardware/software required. FIG. 6 illustrates how, within a multi-CSP system, a scaled product of two vectors ((C×V₁)×V₂), where V₁ and V₂ are vectors and C is a scalar constant, can be computed using two CSPs according to certain embodiments of the invention (CSP_7 601 and CSP_8 602). Note that the complex vector computations are effectively chained over two CSPs and performed in an overlapped (pipelined) fashion. In a typical signal processing application operating on long data streams, CSP_8 602 can start producing ((C×V₁)×V₂) partial results in its output buffer 603 even before a vector operation (C×V1) has been completed by CSP_7 601 and the full result stored in the corresponding output buffer 604. Moreover, CSP_8 602 can start producing ((C×V₁)×V₂) partial results in its output buffer 603 even before the whole input data set is transferred via DMA channel 605 into a designated input buffer 606 of CSP_7 601.

The foregoing is provided for purposes of disclosing certain aspects and embodiments of the invention. Additions, deletions, modifications and other changes may be made to what is disclosed herein without departing from the scope, spirit or ambit of the invention.

What is claimed is:

1. Data processing apparatus capable of executing vector instructions, comprising:
a. a plurality of data buffers whose sizes are configurable in hardware and/or in software;
b. a plurality of buffer control units adapted to control access to said data buffers, at least one buffer control unit including at least one programmable write pointer register, read pointer register, read stride register and vector length register;
c. a plurality of execution units for executing vector instructions using input operands stored in data buffers and storing produced results to data buffers;
d. at least one Direct Memory Access channel transferring data to and from said buffers; and
e. wherein at least some of said data buffers are implemented in dual-ported fashion in order to allow at least two simultaneous accesses per buffer, including at least one read access and one write access.

2. Data processing apparatus according to claim 1 wherein, for said at least one buffer control unit:
a. said write pointer register is adapted to be automatically incremented on each data buffer write access via either a vector instruction or DMA transfer;
b. said read pointer register is adapted to automatically be incremented or decremented on each data buffer read access via a vector instruction;
c. said read pointer register is adapted to be automatically incremented on each data buffer read access via DMA transfer;
d. said read stride register is adapted to be assigned per buffer control unit, such that at the end of a vector instruction, a read pointer corresponding to a vector instruction's input operand(s) is automatically updated by assigning to it a new value equal to a value of the read pointer before the vector instruction execution, incremented by a value contained in the read stride register; and
e. said vector length register is adapted to indicate the number of vector elements to be processed by a vector instruction.

3. Data processing apparatus according to claim 1 wherein:
a. the effective range of at least some of said read and write pointer registers used in buffer addressing is equal to the active buffer size; and
b. address generation arithmetic on contents of read and write pointer registers is performed modulo buffer size.

4. Data processing apparatus according to claim 2 wherein:
a. the effective range of at least some of said read and write pointer registers used in buffer addressing is equal to the active buffer size; and
b. address generation arithmetic on contents of read and write pointer registers is performed modulo buffer size.

5. Data processing apparatus according to claim 1 wherein a plurality of data buffers whose sizes are configurable in hardware are so configurable using a plurality of external pins.

6. Data processing apparatus according to claim 1 wherein a plurality of data buffers whose sizes are configurable in software are so configurable using control registers.

7. Data processing apparatus capable of executing vector instructions, comprising:
a. a plurality of data buffers whose sizes are configurable in hardware and/or in software;
b. a plurality of buffer control units adapted to control access to said data buffers, at lease one buffer control unit including at least one programmable write pointer register, read pointer register, read stride register and vector length register;
c. a plurality of execution units for executing vector instructions using input operands stored in data buffers and storing produced results to data buffers;
d. at least one Direct Memory Access channel transferring data to and from said buffers; and
e. wherein at least some of said data buffers are implemented in dual-ported fashion in order to allow at least two simultaneous accesses per buffer, including at least one read access and one write access; wherein, for said at least one buffer control unit:
f. said write pointer register is adapted to be automatically incremented on each data buffer write access via either a vector instruction or DMA transfer;
g. said read pointer register is adapted to automatically be incremented or decremented on each data buffer read access via a vector instruction;
h. said read pointer register is adapted to be automatically incremented on each data buffer read access via DMA transfer;
i. said read stride register is adapted to be assigned per buffer control unit, such that at the end of a vector instruction, a read pointer corresponding to a vector instruction's input operand(s) is automatically updated by assigning to it a new value equal to a value of the read pointer before the vector instruction execution, incremented by a value contained in the read stride register; and
j. said vector length register is adapted to indicate the number of vector elements to be processed by a vector instruction.

8. Data processing apparatus according to claim 7 wherein:
a. the effective range of at least some of said read and write pointer registers used in buffer addressing is equal to the active buffer size; and
b. address generation arithmetic on contents of read and write pointer registers is performed modulo buffer size.

9. A method of data processing, comprising:
a. providing data processing apparatus capable of executing vector instructions, said apparatus comprising:
1. a plurality of data buffers whose sizes are configurable in hardware and/or in software;
2. a plurality of buffer control units adapted to control access to said data buffers, at lease one buffer control unit including at least one programmable write pointer register, read pointer register, read stride register and vector length register;
3. a plurality of execution units for executing vector instructions using input operands stored in data buffers and storing produced results to data buffers;
4. at least one Direct Memory Access channel transferring data to and from said buffers; and
5. wherein at least some of said data buffers are implemented in dual-ported fashion in order to allow at least two simultaneous accesses per buffer, including at least one read access and one write access;
b. accessing a plurality of source data buffers, each containing at least one input operand array in response to one said vector instruction;
c. detecting, before execution of a vector instruction, whether there is at least one input operand element in each of the source buffers; and
d. prohibiting execution of the vector instruction if any of said source buffers is empty.

10. A method of data processing, comprising:
a. providing data processing apparatus capable of executing vector instructions, said apparatus comprising:
1. a plurality of data buffers whose sizes are configurable in hardware and/or in software;
2. a plurality of buffer control units adapted to control access to said data buffers, at lease one buffer control unit including at least one programmable write pointer register, read pointer register, read stride register and vector length register;
3. a plurality of execution units for executing vector instructions using input operands stored in data buffers and storing produced results to data buffers;
4. at least one Direct Memory Access channel transferring data to and from said buffers; and
5. wherein at least some of said data buffers are implemented in dual-ported fashion in order to allow at least two simultaneous accesses per buffer, including at least one read access and one write access;
b. accessing at least one source data buffer which includes at least one input operand array to be transferred via said direct memory access channel;
c. detecting, before execution of said direct memory access transfer, whether there is at least one input operand element in a said source buffer; and
d. prohibiting execution of said direct memory access transfer if said source buffer is empty.
